(19) United States
(12) Patent Application Publication
(10) Pub. No.: US 2020/0361021 A1
(43) Pub. Date: Nov. 19, 2020

(54) METHOD FOR PRODUCTION OF RESISTANCE SPOT-WELDED JOINT

(71) Applicant: NIPPON STEEL CORPORATION, Tokyo (JP)

(72) Inventors: Seiji FURUSAKO, Tokyo (JP); Masanori YASUYAMA, Tokyo (JP)

(73) Assignee: NIPPON STEEL CORPORATION, Tokyo (JP)

(21) Appl. No.: 16/768,004

(22) PCT Filed: Dec. 19, 2018
(86) PCT No.: PCT/JP2018/046887

§ 371 Date: May 28, 2020

(30) Foreign Application Priority Data
Dec. 19, 2017 (JP) 2017-242970

(51) Int. Cl. B23K 11/11

(52) U.S. Cl. CPC B23K 11/11

(57) ABSTRACT

The method for the production of a resistance spot welded joint according to the present invention can suppress the occurrence of spatter and can stably ensure nugget diameter in the spot welding of steel sheets in which a material having a high electrical resistance is present on the surface layer thereof. The method for the production of a welded joint according to the present invention is characterized by a tip diameter of the electrode, which is the diameter of a circle which is equivalent in area to a region in which a surface region of a tip surface of the electrode having a radius of curvature of 40 mm or more is projected onto a surface perpendicular to a direction of pressure of the electrode, is 8.0 mm or more, the method including a preliminary conduction step of applying a direct current Ia(t) (kA) for a conduction time ta seconds so as to satisfy formulas (1) and (2) below while pressing the electrode with a pressure of 5.5 kN or more, and a main conduction step of energizing with direct current while pressing the electrode with a pressure of 5.0 kN or more after the preliminary conduction step, wherein the current Ia(t) is continuously supplied for 80% or more of ta.

[Math 1]

Ia(t)≤6.0 (kA) formula (1)

0.5(kA·s)≤∫₀^{ta}Iₐ(t)dt≤2.0(kA·s) formula (2)

### FIELD

The present invention relates to a method for the production of a steel sheet resistance spot-welded joint.

### BACKGROUND

Automobile bodies are assembled by joining press-formed steel sheets primarily by spot welding mainly by means of resistance welding. In spot welding, it is necessary to both ensure a nugget diameter corresponding to the thicknesses of the sheets and suppress the occurrence of spatter (expulsion).

Recently in the automotive field, the use of high-strength steel sheets in frame components to ensure weight reduction and collision safety of vehicle body is expanding. Specifically, the use of hot-stamped steel sheets which are hot-formed using high-strength steel sheets is expanding since both a high forming accuracy and low press load can be achieved therewith.

However, when high-strength steel sheets are spot-welded using a single-stage conduction method, spatter is likely to occur, whereby it becomes difficult to ensure a suitable current range. Furthermore, if zinc plating or aluminum plating is present on the surfaces of the steel sheets for hot-stamping, during heating, the plating oxidizes, whereby zinc oxide or aluminum oxide is formed. If these oxides grow, the contact resistance of the steel sheets increases. As a result, there is a problem in that spatter is likely to occur in the vehicle body spot welding assembly, whereby it becomes difficult to ensure the stability of the nugget diameter.

In connection with such problems, Patent Literature 1 discloses a spot-welding method in which the occurrence of spatter in high-strength steel sheet spot-welding is suppressed by adopting a two-stage conduction method in which main conduction is performed after conformity between faying surfaces of the steel sheets is increased by preliminary conduction.

Patent Literature 2 discloses a spot-welding method in which the occurrence of spatter is suppressed in the spot-welding of high-strength steel sheets by adopting a conduction method in which the current value is reduced after a nugget having a 3√t to 5√t diameter is formed by preliminary conduction, and thereafter, the current is increased again to perform constant current main conduction or pulse-like main conduction.

As an example in which such a two-stage conduction method by preliminary conduction and main conduction is used in the spot-welding of hot-stamped steel sheets, Patent Literature 3 discloses a spot-welding method in which hot-stamped steel sheets, which are covered with a high electrical resistance film such as zinc oxide, are spot-welded, wherein preliminary conduction is performed by pulsation conduction in which conduction and conduction idling are repeated a plurality of times while pressing the steel sheets with the electrodes, and thereafter main conduction is continuously performed for a time greater than the maximum conduction time of the pulsation conduction.

Further, Patent Literature 4 discloses a spot-welding method in which steel sheets identical to those of Patent Literature 3 are spot-welded, wherein preliminary conduction and main conduction are performed by pulsation conduction, and the maximum current of the main conduction is greater than the maximum current of the preliminary conduction.

In Patent Literature 3 and 4, during the pulsation conduction of the preliminary conduction, conduction and conduction idling are repeated, whereby vibration due to thermal expansion and contraction can be imparted to the electrode faying surface of the steel sheet, effectively excluding the high melting point oxide layer to outside the weld zone, and by stopping the conduction of the pulsation conduction, cooling of the electrode can be sufficiently achieved and a rapid temperature rise of the weld can be suppressed. Thus, conformity between the faying surfaces of the steel sheets can be increased in a short time while suppressing the occurrence of spatter, and an increase in current density at the contact interface and rapid nugget growth can be suppressed. As a result, the occurrence of spatter in the spot-welding of hot-stamped steel sheets can be suppressed.

Patent Literature 5 discloses a spot-welding method in which the pressure applied by the electrode is maintained within a suitable range in accordance with the thicknesses of the steel sheets, and the conduction pattern is maintained within a suitable range, whereby nugget diameter is ensured while the occurrence of indentation is suppressed, and the occurrence of expulsion is prevented.

### CITATION LIST

### Patent Literature

[PTL 1] Japanese Unexamined Patent Publication (Kokai) No. 2010-188408

[PTL 2] Japanese Unexamined Patent Publication (Kokai) No. 2010-207909

[PTL 3] WO 2015/005134

[PTL 4] WO 2015/093568

[PTL 5] WO 2014/045431

### SUMMARY

### Technical Problem

In order to prevent the generation of iron scale during high-temperature heating, the steel sheets used in hot-stamping are commonly subjected to surface treatment such as zinc plating or aluminum plating. When such surface-treated steel sheets are hot-stamped, oxidation of the plating progresses during heating, and a zinc oxide or aluminum oxide layer forms. If such oxide layers grow, the contact resistance of the steel sheet after hot-stamping (hot-stamped steel sheet) increases to 1 mΩ or more. In the spot-welding assembly of a vehicle body or the like using such hot-stamped steel sheet, there are problems in that spatter can easily occur, and it is difficult to suitably ensure nugget diameter.

In the technologies disclosed in Patent Literature 3 and 4, the high-melting point oxide layer is limited to outside the weld portion by adopting pulsation conduction (conduction in which conduction and conduction idling are repeated a plurality of times over a short period) using an inverter DC welding power source, whereby conformity between the faying surfaces of the steel sheets can be increased during preliminary conduction. However, in some cases, the effect is not sufficient, such as when the oxide layer is thick, and thus, the suppression of the occurrence of spatter even in such a case is desired. Furthermore, since such technology has advantages such as the power supply being small, inverter DC power supplies, which have recently become mainstream, have a problem in that the suitable current range becomes narrower than AC, as disclosed in Patent Literature 4. Thus, a welding method using an inverter DC power supply with which a wider suitable current range can be obtained even in continuous conduction in which there is little pulsation or conduction in which no repetition of short-term conduction idling is desired.

In the technology disclosed in Patent Literature 5, though the nugget diameter is ensured and the generation of spatter is suppressed by varying pressure in accordance with sheet thickness and further adopting a suitable conduction pattern range, the effect may not be sufficient, such as when the oxide layer is thick, and thus, further suppression of spatter even in such a case is desired.

In light of such circumstances, an object of the present invention is to provide a spot welding technology with which the occurrence of spatter can be suppressed during the spot welding of steel sheets including at least one hot-stamped steel sheet.

### Solution to Problem

Means to stably ensure nugget diameter by dispersing or moving surface high-resistance material to suppress the occurrence of spatter when spot welding is performed to combine steel sheets having high contact resistance, in which a high electrical resistance material such as zinc oxide is formed on the surface layers thereof even in the case in which continuous conduction with substantially no pulsation conduction is adopted using an invert DC welding power source have been investigated.

As a result, it has been discovered that when preliminary conduction is performed prior to main conduction, as in Patent Literature 1 to 4, under conditions in which an electrode having a large tip diameter is used and the pressure applied to the steel sheet is increased, it is possible to effectively disperse or move the material having a high electrical resistance on the surface layer, whereby the current at which spatter occurs during main conduction is increased, and the suitable welding current range can be expanded.

Further, as a result of further investigation of the tip diameter of the electrode, the pressure applied to the steel sheet, and the conduction conditions of the preliminary conduction, the present inventors have discovered conditions under which substances having a high electrical resistance on the surface layer are dispersed or moved, whereby the occurrence of spatter is suppressed and the nugget diameter can be ensured.

The gist of the present invention, which has been conceived in this manner, is as follows.

(1) A method for the production of a resistance spot-welded joint in which two or more steel sheets are superposed, and an superposed portion thereof is pressed and energize by an electrode, wherein

a tip diameter of the electrode, which is the diameter of a circle which is equivalent in area to a region in which a surface region of a tip surface of the electrode having a radius of curvature of 40 mm or more is projected onto a surface perpendicular to a direction of pressure of the electrode, is 8.0 mm or more,

the method comprising:

a preliminary conduction step of applying a current Ia(t) (kA) for a conduction time ta seconds so as to satisfy formulas (1) and (2) below while pressing the electrode with a pressure of 5.5 kN or more, and

a main conduction step of energizing while pressing the electrode with a pressure of 5.0 kN or more after the preliminary conduction step, wherein

current in the preliminary conduction step and the main conduction step is direct current, and

80% or more of the conduction method of each of the preliminary conduction time ta seconds and the conduction time of the main conduction step is continuous conduction in which conduction is continuously performed.

[Math 1]

Ia(t)≤6.0 (kA) formula (1)

0.5(kA·s)≤∫₀^{ta}Iₐ(t)dt≤2.0(kA·s) formula (2)

(2) The method for the production of a resistance spot-welded joint according to (1) above, wherein current is increased in the preliminary conduction step.

(3) The method for the production of a resistance spot-welded joint according to (1) or (2) above, wherein current is increased in the main conduction step.

(4) The method for the production of a resistance spot-welded joint according to any one of (1) to (3) above, wherein a conduction method of the preliminary conduction step comprises continuous conduction.

(5) The method for the production of a resistance spot-welded joint according to any one of (1) to (4) above, wherein a conduction method of the main conduction step comprises continuous conduction.

(6) The method for the production of a resistance spot-welded joint according to any one of (1) to (5) above, wherein a contact resistance of at least one of the steel sheets is 1 mΩ or more.

### Advantageous Effects of Invention

According to the present invention, there is provided a welding method in which steel sheets having a high electrical resistance material present on a surface thereof, such as hot-stamped steel sheets, are spot-welded primarily by continuous conduction with direct current, the occurrence of spatter can be suppressed, and nugget diameter can be stably ensured.

### BRIEF DESCRIPTION OF DRAWINGS

FIG. 1 is a graph representing nugget growth behavior in the case in which a 1800 MPa class hot-stamping material having a thickness of 1.4 mm is spot welded by continuous conduction using an inverter DC welding power source while changing the conduction pattern, electrode diameter, and applied pressure.

FIG. 2 is a view showing an example of a spot-welding conduction pattern.

FIG. 3 is a view detailing the electrode tip diameter.

FIG. 4 is a view detailing an example of spot-welding conduction patterns.

FIG. 5 is a view detailing a conduction pattern when pulsation conduction is used in main conduction.

FIG. 6 is a view detailing a contact resistance measurement method.

### DESCRIPTION OF EMBODIMENTS

The embodiments of the present invention will be described below with reference to the attached drawings.

When hot-stamped steel sheets (surface-treated hot-stamped steel sheets) produced by hot-stamping steel sheets which have been subjected to a surface treatment such as hot-dip plating are resistance spot-welded, inner spatter and outer spatter can easily occur, and the suitable current range becomes significantly more narrow, whereby the current at which spatter occurs becomes lower. Therefore, when welding is performed at a current value within this suitable current range (excluding currents in the vicinity of the upper limit of the suitable current range) so as to prevent the occurrence of spatter, the diameter of the obtained nugget is also reduced.

“Suitable current range” as used herein means, when the average value of the thickness of the steel sheet to be spot-welded is defined as t, the range from the initial current (hereinafter referred to as the “4√t it current”) at which the nugget diameter becomes 4√t or greater to the current at which spatter first occurs while gradually increasing the current.

The cause of the ease of spatter and narrowing of the suitable current range when surface-treated hot-stamped steel sheets are resistance spot-welded will be considered as follows.

In surface-treated hot-stamped steel sheets, an intermetallic compound and an iron-based solid solution are formed on the surface thereof by an alloying reaction between the plating metal and the base steel, and the outer surface thereof has an oxide film mainly composed of a metal (e.g., Zn) derived from the plating. Thus, surface-treated hot-stamped steel sheets have a higher resistance at the contact portion between the steel sheets and a larger calorific value as compared to cold-pressed steel sheets.

However, since the alloying of the plated metal and steel progresses in the hot stamping process and the melting point near the surface has a high value close to that of iron, it is difficult to soften the contact portion between the steel sheets, as compared with the plated steel sheet prior to hot stamping, whereby enlargement of the conduction path is suppressed. In particular, (inverter) DC type conduction has a higher heat generation efficiency than single-phase alternating current, whereby nugget formation during the initial stage of conduction becomes very rapid. Thus, it is assumed that the growth of the pressure weld around the nugget cannot maintain pace, whereby the molten metal cannot be confined, and inner spatter occurs.

Furthermore, since direct current does not have a current idle time, unlike single-phase alternating current, it is difficult to obtain a cooling effect with the electrode. Thus, it is presumed that the nugget can easily grow in the thickness direction, whereby the molten portion reaches the outermost surface layer of the steel sheet, and outer spatter occurs. In the present invention, “direct current” refers to current which does not change in flow direction (positive/negative), even if the magnitude thereof changes over time, and encompasses the case in which the magnitude becomes 0 Amperes over time. Thus, not only conduction in which the current always flows, such as in continuous conduction, but also pulsation conduction in which conduction and conduction idling repeat multiple times in a short time are determined to be direct current, unless the polarity reverses.

The present inventors have first examined means for separating the oxide layer and reliably removing it to the outside of the weld, regardless of the thickness of the oxide layer in the preliminary conduction step of spot welding by two-stage conduction by means of a continuous DC conduction method.

As a result, when high pressure is applied to a hot-stamped steel sheet by an electrode with a large diameter tip, the contact area between the tip of the electrode and the steel sheet is increased, whereby the range in which oxides can be dispersed and moved is expanded. An increase in applied pressure results in an increase in surface pressure, whereby the effect of oxide dispersion/movement (exclusion) is increased. Further, it has been discovered that since the cooling effect of the steel sheet surface layer is high due to the cooling effect of the electrode, specifically the occurrence of outer spatter is suppressed.

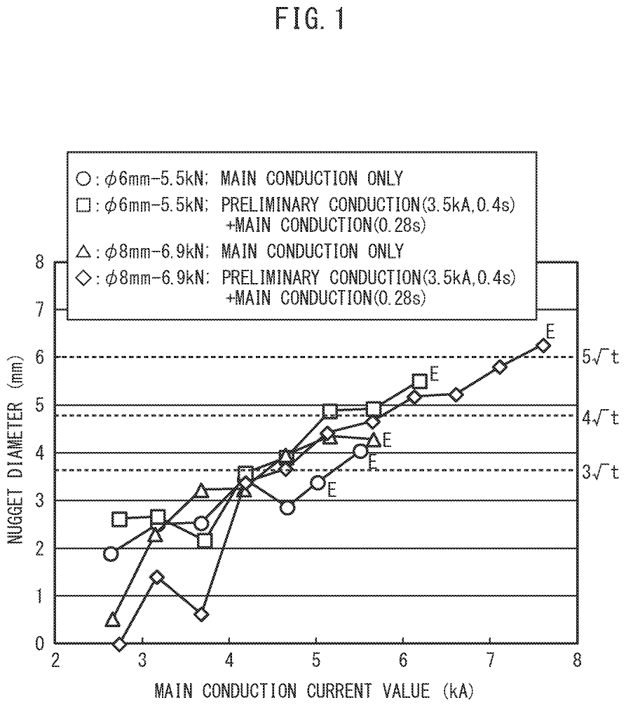

FIG. 1 shows an example of examination results from which such findings were obtained.

In the examination, when two hot-stamped galvanized steel sheets (hot-stamped steel sheets) having sheet thicknesses of 1.4 mm were combined, the nugget growth behavior was examined when the tip diameter of the electrode was changed and the pressure applied by the electrode to the superposed portion of the steel sheets was changed, and the current value of main conduction was increased until spatter occurred for the case in which spot welding was performed by single-stage conduction including only main conduction was performed and the case in which two-stage conduction including a preliminary conduction step and a main conduction step was performed.

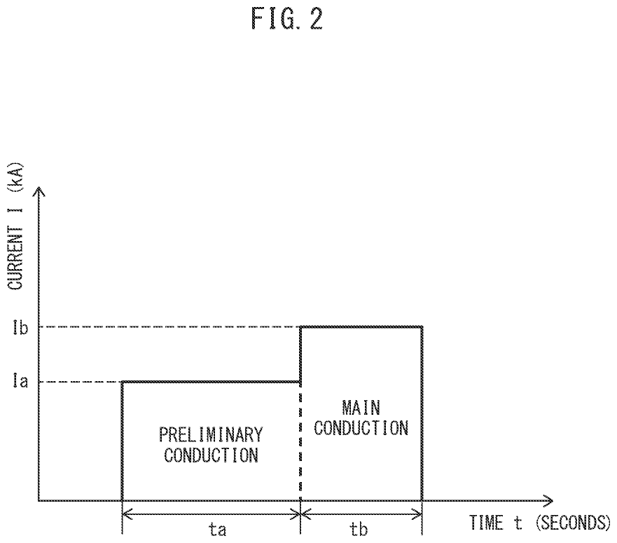

As shown in FIG. 2, two-stage conduction uses a conduction pattern in which preliminary conduction is performed at a current value Ia of 3.5 kA for a conduction interval to (=0.4 seconds), and thereafter main conduction is performed at various current values Ib for a conduction interval tb (the conduction interval of the main conduction is 0.28 seconds).

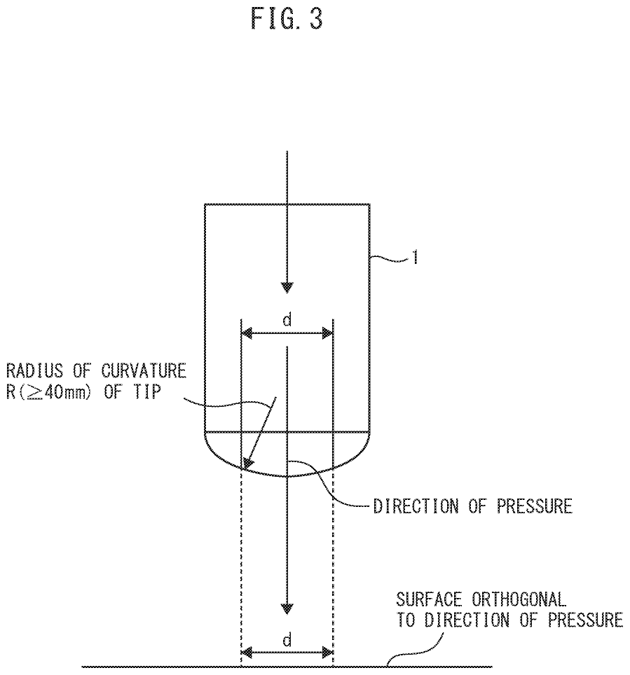

As the electrodes, DR (dome radius) type electrodes, as shown in FIG. 3, having an electrode tip diameter d (initial contact area), which is described later, of 6.0 mm (conventional electrode) and 8.0 mm (thick electrode) were used. The applied pressure during conduction, in the case in which an electrode having an electrode tip diameter of 6.0 mm, was 5.5 kN (low-pressure), and in the case in which an electrode having an electrode tip diameter of 8.0 mm, was 6.9 kN (high-pressure).

FIG. 1 shows spot welding results of four patterns including low pressure+conventional electrode+only main conduction, low pressure+conventional electrode+additionally preliminary conduction, high pressure+thick electrode+only main conduction, and high pressure+thick electrode+additionally preliminary conduction. Points E in FIG. 1 represent the experimental points at which spatter occurred.

As shown in FIG. 1, the upper limit current value at which spatter occurs is increased, with respect to the case in which only main conduction is performed and spot welding is performed with a conduction pattern in which preliminary conduction is not performed, by welding with two-stage conduction. In particular, in addition to preliminary conduction, it has been confirmed that when welding is executed at a high pressure with a thick electrode, the upper limit current value at which spatter occurs is greatly increased and the appropriate welding current range is expanded as compared to the case of conventional conditions (low pressure +normal electrode+main conduction only) or the case in which welding is performed with preliminary conduction and low pressure+normal electrode.

In consideration of the above findings, as a result of investigation into conditions to obtain the required nugget diameter by changing the tip diameter of the electrode, the pressure of the electrode, and conduction conditions of the preliminary conduction to suppress spatter, assuming that conduction is performed in two stages including preliminary conduction and main conduction, the present inventors have further discovered that by setting the conditions defined by the above formulas (1) and (2), the appropriate welding current range, with which a necessary nugget diameter can be obtained without the occurrence of spatter, is expanded.

The present invention has been achieved based on such investigation results, and the necessary requirements and preferred requirements of the present invention will be further described below.

(Steel Sheet to be Spot-Welded)

In the present invention, the primary target for spot-welding is steel sheets which have been hot-stamped (hereinafter referred to as hot-stamped steel sheets) produced by heating a steel sheet blank formed from high-strength steel (e.g., thin steel sheets including electroplated steel sheets or hot-dipped steel sheets) to a quenchable temperature to form austenite, and thereafter press-molding while simultaneously cooling and quenching, wherein the steel sheets have been hot-stamped by using the steel sheet blank which have been subjected to a surface treatment, such as zinc plating or aluminum plating, to prevent the occurrence of iron scaling when heated to high temperatures. The present invention can be appropriately applied to steel sheets other than hot-stamped steel sheets, and it is not necessary that the present invention be limited in particular to hot-stamped steel sheets.

It should be noted that in many cases, hot stamped steel sheets are not flat sheets but formed products, and it is only necessary that the portions to be superposed be sheet-like. Thus, in the present invention, the phrase “hot-stamped steel sheets” also encompasses the case in which formed products are used. Furthermore, hot-stamped steel sheets obtained by hot-stamping zinc-plated steel sheets or aluminum-plated steel sheets are referred to as “surface-treated hot-stamped steel sheets” in the description below in some cases.

In hot-stamped steel sheets, an intermetallic compound and an iron-based solid solution are formed on the surface thereof by an alloying reaction between the zinc-based or aluminum-based plating film and the base steel, and the outer surface thereof has an oxide film mainly composed of a metal derived from the plating (e.g., zinc for zinc-based plating). Thus, surface-treated hot-stamped steel sheets have a high contact resistance of 1 mΩ or more and a large quantity of heat generated by the conduction as compared to bare steel sheets. Furthermore, in hot-stamped steel sheets, since the melting point near the surface has a high value close to that of iron as the alloying of the plated metal and steel progresses in the hot stamping process, it is difficult to soften the contact portion between the steel sheets as compared with the plated steel sheet prior to hot stamping. The present invention is particularly effective when applied to the spot welding of such steel sheets having a contact resistance of 1 mΩ or more. Note that the method for measuring contact resistance will be described later.

The sheet thickness of the steel sheets is not particularly limited. The sheet thicknesses of the steel sheets used in automotive components or vehicle bodies are generally 0.6 to 3.2 mm, and the method for the production of a spot-welded joint according to the present invention has sufficient effects within this range.

(Sheet Assembly)

The sheet assembly when two or more steel sheets are superposed preferably includes at least one surface-treated hot-stamped steel sheet on the electrode side. The steel sheets combined with the surface-treated hot-stamped steel sheet are preferably a combination including surface-treated hot-stamped steel sheets or high-tensile steel sheets of 590 MPa class or higher. In conventional automobile assemblies, resistance spot welding is performed on a sheet assembly in which two or three of such steel sheets are superposed.

(Electrode)

In the present invention, the tip diameter d of the electrode is defined as the diameter of a circle (a so-called “equivalent circle diameter”) which is equivalent in area to the area A of a region in which a surface region (the surface region includes the furthest projecting portion of the electrode) of a tip surface of the electrode having a radius of curvature of 40 mm or more is projected onto a surface perpendicular to the direction of pressure (conventionally identical to the longitudinal method of the electrode) of the electrode. In other words, the tip diameter d of the electrode is calculated as 2√(A/π). According to this definition, as shown in, for example, FIG. 3, in the case of a circle, the tip diameter d of the electrode is defined as the diameter of the circle in which the surface region in which the radius of curvature is 40 mm or more is projected onto a surface perpendicular to the direction of pressure (conventionally identical to the longitudinal method of the electrode) applied to the superposing portion of the steel sheets by the electrode.

In the present invention, the tip diameter d of the electrode is 8.0 mm or more. The tip diameter d is preferably greater than 8.0 mm, and may be 8.5 mm or more, 9.0 mm or more, 9.5 mm or more, or 10.0 mm or more. Though the upper limit of the tip diameter d is not particularly limited, it is limited by the shape of the welded part and the structure of the electrode mounting part of the welding device, and is generally about 12.0 mm. The upper limit of the tip diameter d may be 11.0 mm or less or 10.5 mm or less, as necessary.

By adopting an electrode having a large tip diameter in this manner, i.e., an electrode having a thick tip diameter, the area of contact with the steel sheet is increased, and the range across which oxidation is eliminated is increased. Furthermore, by adopting an electrode having a thick tip diameter, since the effect of cooling of the steel sheet surface by the electrode is enhanced, the occurrence specifically of outer spatter is suppressed.

Electrodes as prescribed in, for example, JIS C9304:1999 can be used as the electrode. Among these, in order to make the electrode tip diameter d equal to 8.0 mm or more, a DR type electrode having a tip radius of curvature of 40 mm or more, or a CR type electrode having a large frustoconical diameter at the tip of the electrode can be used. For example, a DR-type electrode of which a curvature R of the tip curved surface is 40 to 60 mm can be used.

The electrode material is preferably chromium copper or alumina-dispersed copper, but alumina-dispersed copper is more desirable from the viewpoints of welding and the prevention of outer spatter.

(Welding Power Supply)

Conduction in spot welding includes conduction using a DC welding power supply such as an inverter DC system. Inverter DC systems have a merit of being able to be used in a robot with a small transformer and a small payload, and are thus often used in particular in automated lines.

Since inverter DC systems continuously supply current without current on/off cycles as in conventional single-phase AC systems, the heat generation efficiency thereof is high.

(Pressurization/Conduction Conditions)

FIG. 2 shows a time chart of a specific example of a conduction pattern in spot welding. In this conduction pattern, first, preliminary conduction, in which conduction is performed at a current value Ia while applying a predetermined pressure to the superposed portion of the steel sheets, is performed, and thereafter, main conduction, in which conduction is performed at a current value Ib so that the nugget reaches a predetermined diameter, is performed. It is preferable that Ib be higher than Ia. Further, after main conduction has completed, when a predetermined holding time has elapsed, the electrode is separated from the steel sheet and the applied pressure is released.

At this time, an electrode having an electrode tip diameter of 8.0 mm or more, as described above, is used, and the pressure applied by the electrode and the conduction conditions of the preliminary conduction are set to specific conditions.

During preliminary conduction, in a state in which the electrode contacts the surface of the steel sheet across a wide area, the applied pressure is increased, the oxide layer on the surface of the steel sheet is dispersed, and a part of the oxide is moved (excluded) to outside the area of contact with the electrode, whereby the contact resistance of the surface is reduced. Furthermore, the current value is reduced to suppress rapid growth of the nugget in the early stages of contact and to prevent the occurrence of spatter.

To this end, the applied pressure is set to 5.5 kN or more. The applied pressure is preferably 5.9 kN or more, and further preferably 6.0 kN or more, 6.3 kN or more, 6.5 kN or more, or 6.9 kN or more. When the applied pressure increases beyond a suitable range, for example, the divot caused in the sheet by the pressure applied by the electrode becomes large (a part with a thin sheet thickness is formed locally), whereby the joint strength decreases, or the current density is drastically reduced, whereby nugget formation during main conduction becomes difficult in some cases. Thus, the applied pressure is preferably 10.0 kN or less, 9.5 kN or less, or 9.0 kN or less.

Further, the primarily conduction is performed for ta seconds so as to satisfy formulas (1) and (2) below while a pressing the electrode with the applied pressure.

Ia(t)≤6.0 (kA) formula (1)

[Math 2]

0.5(kA·s)≤∫₀^{ta}Iₐ(t)dt≤2.0(kA·s) formula (2)

However, Ia(t) (kA) in formula (1) and formula (2) is the current value of the preliminary conduction when t hours have elapsed since the start of the preliminary conduction, and the current Ia(t) is continuously applied for 80% or more of ta.

In order to demonstrate the effects of preliminary conduction, the current integration value S in the preliminary conduction defined by the following formula (3) is set to 0.5 kA·s or more, as shown in formula (2). As necessary, the lower limit of the current integration value S may be set to 0.6 kA·s, 0.8 kA·s, 1.0 kA·s, or 1.2 kA·s. Though it is not necessary to specifically prescribe the conduction interval of the preliminary conduction, cases in which the conduction interval is 0.05 to 1 s are common. As necessary, the lower limit of the conduction interval may be set to 0.1 s, 0.15 s, or 0.2 s, and the upper limit thereof may be set to 0.9 s, 0.8 s, 0.7 seconds, or 0.8 s.

[Math 3]

S=∫₀^{ta}Iₐ(t)·dt formula (3)

It should be noted that as described above, in the embodiments of the present invention, the current in the preliminary conduction (when the current during preliminary conduction is variable, the maximum value of the current during preliminary conduction) is set to 6.0 kA or less. Though it is not necessary to specifically prescribe the lower limit of the current during preliminary conduction, in consideration of pulsation conduction, the lower limit thereof is 0 kA. As necessary, the lower limit may be 1.0 kA or 2.0 kA.

Since the purpose of preliminary conduction is mainly to destroy the oxide layer of the portion of the surface of the steel sheet which contacts with the electrode and to remove a part of the oxide layer to outside of the contact range, the nugget may not be formed during preliminary conduction.

The conduction interval in preliminary conduction is longer than the time during which the oxide layer on the surface of the steel sheet can be separated and removed, and is determined so as to satisfy the above relationship with the current value Ia(t).

In preliminary conduction, the conduction, as described above, is continuous conduction for 80% or more of the duration of the preliminary conduction. Continuous conduction as used herein means conduction in which the magnitude of the DC current does not become 0 Amperes. In continuous conduction, a constant magnitude of current may be continuously supplied, the magnitude of the DC current may increase over time, or the magnitude of DC current may increase and decrease over time, as long as the magnitude of the DC current does not become 0 Amperes. However, conduction including long-term conduction idlings (e.g., conduction idlings of one second or more), which are not normally included in pulsation conduction, is not included in continuous conduction. Furthermore, the conduction in preliminary conduction may be continuous conduction for 85% or more of the preliminary conduction interval, or may be 100% continuous conduction. It should be noted that though short-time (e.g., approximately 0.01 to 0.1 seconds) conduction idle times, as in pulsation conduction, are included in conduction interval, conduction idle times of one second or more are excluded from the conduction interval.

In main conduction, which follows preliminary conduction, conduction is performed while the electrode applies a pressure of 5.0 kN or more. In the embodiments of the present disclosure, the suitable current range is sufficiently wide. Thus, it is possible to spot weld under the same conditions as non-hot-stamped steel sheets, except for the increase in the applied pressure, as described above. Therefore, aside from energizing while the electrode applies a pressure of 5.0 kN or more, there is no need to provide details regarding the conditions of main conduction. If necessary, a preliminary test within the range of conventional knowledge may be performed to determine the welding conditions for main conduction. It is not necessary to specifically prescribe the conduction interval of main conduction, and conduction intervals of 0.05 to 1 second are common. If necessary, the lower limit of the conduction interval may be 0.1 seconds, 0.15 seconds, or 0.2 seconds. The upper limit may be 0.9 seconds, 0.8 seconds, 0.7 seconds, or 0.6 seconds.

Though it is not necessary to specifically prescribe the current value time integration range (corresponding to the left side of formula (2) during preliminary conduction) during main conduction, ranges of 1.0 to 20.0 kA·s are common. If necessary, the lower limit thereof may be 2.0 kA·s, 3.0 kA·s, or 5.0 kA·s. The upper limit may be 15.0 kA·s, 12.0 kA·s, 10.0 kA·s, or 9.0 kA·s. The current value time integration of main conduction is normally greater than the current value time integration of preliminary conduction.

Though it is not necessary to specifically prescribe the current range of main conduction, excluding the case of pulsation conduction, the range may be 1.0 to 10.0 kA. The lower limit thereof may be 2.0 kA, 3.0 kA, 5.5 kA, 6.0 kA, or 6.5 kA. The upper limit may be 12.0 kA, 11.5 kA, 11.0 kA, 10.5 kA, or 10.0 kA. In consideration of pulsation conduction, the lower limit of the current is 0 kA. The maximum current value of main conduction is normally greater than the maximum value of preliminary conduction.

In general, a nugget diameter of 4√t or more is often used as a standard for production management. In the present invention, as shown in FIG. 1, a weld joint having a larger nugget diameter without the occurrence of spatter (e.g., 4√t or more) can be obtained.

In the foregoing, a continuous conduction pattern including preliminary conduction and main conduction at constant current values, as shown in FIG. 2, was described as an example of the conduction pattern. However, instead of a constant current value, the current value can be gradually increased or can be increased stepwise.

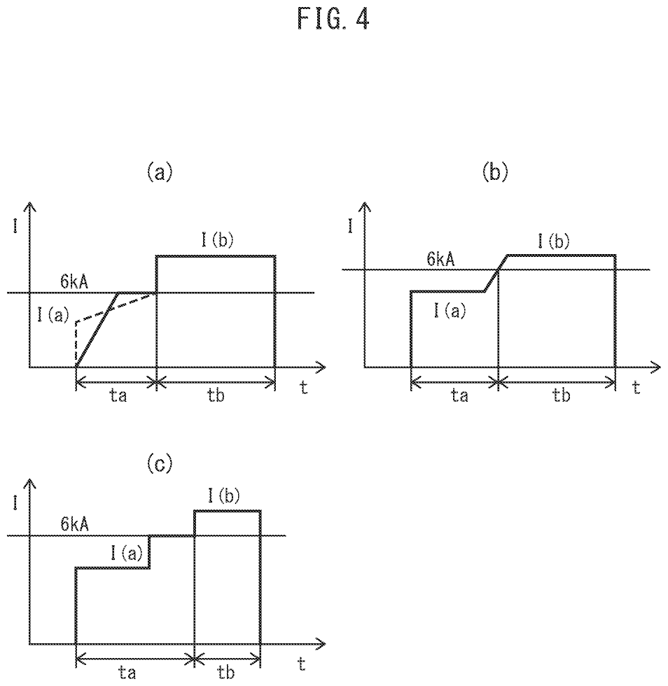

FIG. 4(a) shows an example in which conduction in which the current is gradually increased, i.e., upslope conduction, is performed at the initial start of the preliminary conduction. The solid line represents an example in which upslope conduction is performed from the beginning, and the dashed line represents an example in which upslope conduction is performed from an intermediate current value. By starting preliminary conduction with upslope conduction, nugget formation and rapid growth at the time of high contact resistance during initial conduction can be suppressed.

Furthermore, FIG. 4(b) shows an example in which upslope conduction, in which the current is gradually increased, is performed at the initial start of main conduction, and FIG. 4(c) shows an example in which the current value is increased stepwise during main conduction. However, as described above, it is determined that main conduction has begun when the current Iₐ(t) exceeds 6.0 kA from the start of preliminary conduction.

By starting main conduction with upslope conduction, rapid nugget growth can be suppressed. Furthermore, by increasing the current intermediately, the conduction interval can be shortened.

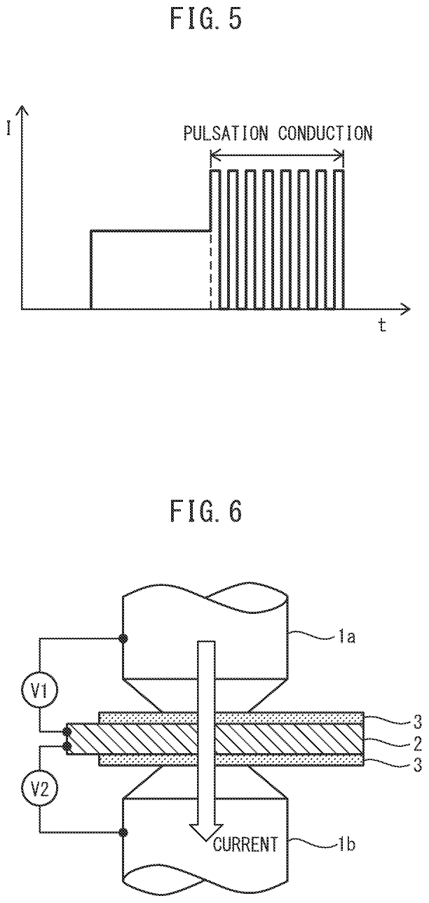

In main conduction, continuous conduction is performed for 80% or more of the conduction interval. Thus, in the present invention, embodiments in which a conduction method such as pulsation conduction is performed for all of main conduction, as shown in FIG. 5, are excluded. A conduction method in which 85% or more of the conduction interval of the main conduction is continuous conduction is preferably performed, and main conduction may be 100% continuous conduction. It should be noted that in the case of short-term interval conduction idling (e.g., the conduction idle time of conventional pulsation conduction is commonly approximately 0.01 to 0.1 seconds), such as pulsation conduction, conduction idle times are also included in the conduction interval. However, in the case of conduction idle times of one second or longer, such conduction idle times are excluded from the conduction interval, and it is sufficient that 80% or more of the conduction interval of the preliminary conduction be continuous conduction.

In the present invention, the definitions of preliminary conduction and main conduction are as described below.

First, in the case of single-stage conduction with constant current conduction (either continuous conduction or pulsation conduction, and regardless of presence or absence of conduction idle times and the length of conduction idle times), only main conduction is performed without preliminary conduction. In the case of conduction in which a stage of conduction at a different constant current is performed after the constant current conduction (either continuous conduction or pulsation conduction, and regardless of the presence or absence of conduction idle times and the length of the conduction idle times), the first stage is preliminary conduction and the second stage is main conduction.

In the case of conduction in which constant current conduction is performed in each stage, in which the currents in the former and latter stages are different, and in which conduction is performed in three or more stages (either continuous conduction or pulsation conduction, regardless of the presence or absence of conduction idle times and the length of the conduction idle times), all conduction after the stage exceeding 6.0 kA for the first time is main conduction, and all conduction prior to main conduction is preliminary conduction (however, when the current in each stage is less than 6.0 kA, the final stage conduction is main conduction, and the conduction prior to main conduction is preliminary conduction).

In the case in which there are increases or decreases during conduction, as in upslope conduction (either continuous conduction or pulsation conduction, and regardless of the presence or absence of conduction idle times and the length of the conduction idle times), all of the conduction after the stage exceeding 6.0 kA for the first time is main conduction, and the conduction prior to main conduction is all preliminary conduction. Therefore, the case in which there is an increase or decrease in current during conduction, as in upslope conduction, and the current is always less than 6.0 kA is not determined as an embodiment of the present invention.

(Contact Resistance)

FIG. 6 shows the method for measuring contact resistance. A steel sheet 2 (which may not include plating layers 3) is interposed between spot welding electrodes 1a, 1b. The welding electrodes 1a, 1b are energized with a current I of 1 A. The voltage V1 between the upper electrode 1a and the steel sheet 2 and the voltage V2 between the lower electrode 1b and the steel sheet 2 are measured.

The electrical resistance between the upper electrode 1a and the steel sheet is defined as R1, the electrical resistance between the lower electrode 1b and the steel sheet is defined as R3, and the resistance caused by the specific resistance of the steel sheet bulk (base material) itself is defined as R2. R2 can be approximated as zero. Furthermore, the resistances of the upper and lower electrodes 1a, 1b can also be approximated as zero. Thus, the relationships between the measured voltages V1, V2 and the electrical resistances R1, R3 can be approximated in the following manner.

V1=(R1+R2)×I≈R1×I=R1×1(A)=R1

V2=(R2+R3)×I≈R3×I=R3×1(A)=R3

In the present invention, the larger of R1 and R3 is the contact resistance.

Though a steel sheet having a contact resistance of 1 mΩ or more is primarily targeted in the present invention, the invention can be applied to a steel sheet having a contact resistance of less than 1 mΩ and it is not necessary to limit to steel sheets having a contact resistance of 1 mΩ or more. If necessary, the lower limit of the contact resistance may be 2 mΩ, 5 mΩ, 8 Ω, or 10 mΩ. Though it is not necessary to specifically prescribe the upper limit of the contact resistance, the upper limit thereof may be 100 mΩ, 50 mΩ, 30 mΩ or 20 mΩ.

Though the present invention is configured as described above, the feasibility and effects of the present invention will be further described below using the Examples.

### EXAMPLE 1

With exception of treatment no. 24, which is described later, resistance spot-welding examinations were performed using a servo pressing type inverter DC spot welding machine comprising DR-type electrodes (chromium copper) having a plurality of types of electrode tip diameters by superposing two GA-plated hot-stamped steel sheets (plating adhesion prior to hot-stamping: 55 g/m² per side; heating conditions: furnace heating at 900° C. for four minutes) having a thickness of 2.0 mm and a strength (tensile strength) of 1500 MPa, and the suitable current ranges were measured. However, some of the examinations were performed in the same manner using two superposed non-hot-stamped steel sheets. In all of the examinations, conduction was performed under the condition Ia(t)<Ib. Table 1 shows the welding conditions and examination results (suitable current range) in addition to the thicknesses, strengths (tensile strength), and contact resistances of the steel sheets under testing. The shape of the test pieces for carrying out the resistance spot welding were strip having a width of 30 mm and a length of 100 mm. When the contact resistances of the steel sheets were measured by the above method, the resistances were 12 mΩ in all cases except for the non-hot stamped steel sheet.

After the preliminary conduction steps were performed at the current values shown in Table 1, the current values in the main conduction steps were changed, and the nugget diameters and the occurrence of spatter were evaluated. The suitable current range of the main conduction step of each evaluation number is shown in Table 1. All of the power supplies were inverter DC power supplies.

As can be understood from Table 1, in the examples of the present invention, since the upper limit current could be increased in the main conduction step, a current range of 1.5 kA or more, which was wider than in the comparative examples in which single-stage conduction was performed, could be obtained at the test piece level. As a result, by setting the current value of the main conduction step to a current of 4√t or more and a value less than the current at which spatter occurs in the present invention, even when welding actual parts, spatter does not occur, and a spot weld portion with a nugget diameter of 4√t or more can be stably secured even if there is a disturbance due to shunting or electrode wear. Conversely, in the comparative examples, the suitable current ranges did not satisfy the target of 1.5 kA or more.

TABLE 1

| | | | | Elec- | Applied | Applied | | | Current | | | | |
|---|---|---|---|---|---|---|---|---|---|---|---|---|---|
| | | | | trode | Pressure | Pressure | | | Integration | | | | |
| | | Steel | | Tip | During | During | | | Value S of | | | | |
| Treat- | Sheet | Sheet | Contact | Diam- | Preliminary | Main | Ia | | Preliminary | Ib | tb | Suitable | |
| ment | Thick- | Strength | Resistance | eter | Conduction | Conduction | (kA) | ta | Conduction | Waveform | (s) | Current | |
| No. | ness | (Mpa) | (mΩ) | (mm) | Pa (kN) | Pb (kN) | (*1) | (s) | (kA · s) | (*2) | (*3) | Range | Remarks |
| 1 | 2.0 | 1530 | 12 | 6.0 | 5.4 | 5.4 | — | — | — | constant | 0.4 | 0.0 | Comp. Ex. |
| 2 | 2.0 | 1530 | 12 | 6.0 | 6.9 | 6.9 | — | — | — | constant | 0.4 | 0.0 | Comp. Ex. |
| 3 | 2.0 | 1530 | 12 | 8.0 | 5.4 | 5.4 | — | — | — | constant | 0.4 | 0.0 | Comp. Ex. |
| 4 | 2.0 | 1530 | 12 | 8.0 | 6.9 | 6.9 | — | — | — | constant | 0.4 | 0.0 | Comp. Ex. |
| 5 | 2.0 | 1530 | 12 | 6.0 | 5.4 | 5.4 | 3.5 | 0.4 | 1.4 | constant | 0.4 | 0.5 | Comp. Ex. |
| 6 | 2.0 | 1530 | 12 | 8.0 | 5.4 | 5.4 | 4.0 | 0.4 | 1.6 | constant | 0.4 | 1.0 | Comp. Ex. |
| 7 | 2.0 | 1530 | 12 | 8.0 | 6.0 | 4.5 | 4.0 | 0.4 | 1.6 | constant | 0.4 | 0.5 | Comp. Ex. |
| 8 | 2.0 | 1530 | 12 | 8.0 | 5.6 | 5.6 | 4.0 | 0.4 | 1.6 | constant | 0.4 | 1.5 | Example |
| 9 | 2.0 | 1530 | 12 | 8.0 | 6.9 | 6.9 | 6.0 | 0.2 | 1.2 | constant | 0.4 | 2.0 | Example |
| 10 | 2.0 | 1530 | 12 | 8.0 | 6.9 | 6.9 | 4.0 | 0.4 | 1.6 | constant | 0.4 | 2.0 | Example |
| | | | | | | | (*5) | | | | | | |
| 11 | 2.0 | 1530 | 12 | 8.0 | 6.9 | 6.9 | 4.0 | 0.4 | 1.6 | upslope | 0.4 | 1.5 | Example |
| | | | | | | | | | | (*7) | | | |
| 12 | 2.0 | 1530 | 12 | 8.0 | 6.9 | 6.9 | 4.0 | 0.4 | 1.6 | pulsation | 0.6 | 1.5 | Example |
| | | | | | | | | | | (*8) | | | |
| 13 | 2.0 | 1530 | 12 | 8.0 | 6.9 | 6.9 | 3.3 | 0.6 | 1.88 | constant | 0.4 | 2.0 | Example |
| | | | | | | | | (*6) | | | | | |
| 14 | 2.0 | 1530 | 12 | 8.0 | 6.9 | 6.9 | 4.0 | 0.4 | 1.6 | constant | 0.4 | 1.5 | Example |
| 15 | 2.0 | 1530 | 12 | 8.0 | 7.8 | 7.8 | 3.0 | 0.6 | 1.8 | constant | 0.4 | 1.5 | Example |
| 16 | 2.0 | 1530 | 12 | 8.0 | 6.9 | 6.9 | 7.0 | 0.4 | 2.8 | constant | 0.4 | 0.0 | Comp. Ex. |
| 17 | 2.0 | 1530 | 12 | 8.0 | 6.9 | 6.9 | 4.0 | 0.6 | 2.4 | constant | 0.4 | 0.0 | Comp. Ex. |
| 18 | 2.0 | 1530 | 12 | 8.5 | 6.9 | 6.9 | 4.0 | 0.4 | 1.6 | constant | 0.4 | 2.0 | Example |
| 19 | 2.0 | 1530 | 12 | 9.0 | 6.9 | 6.9 | 4.0 | 0.4 | 1.6 | constant | 0.4 | 2.0 | Example |
| 20 | 2.0 | 1530 | 12 | 9.0 | 6.9 | 6.9 | 4.5 | 0.4 | 1.8 | constant | 0.4 | 2.0 | Example |
| 21 | 2.0 | 1530 | 12 | 9.0 | 6.9 | 6.9 | 3.0 | 0.6 | 1.8 | constant | 0.4 | 2.5 | Example |
| 22 | 2.0 | 1530 | 12 | 9.0 | 5.4 | 5.4 | 4.5 | 0.4 | 1.8 | constant | 0.4 | 0.5 | Comp. Ex. |
| 23 | 2.0 | 1530 | 12 | 9.0 | 6.9 | 6.9 | 6.5 | 0.5 | 3.25 | constant | 0.4 | 0.0 | Comp. Ex. |
| 24 | 2.0 | 1530 | 12 | 10.0 | 6.9 | 6.9 | 3.0 | 0.6 | 1.8 | constant | 0.4 | 2.5 | Example |
| 25 | 2.0 | 1530 | 12 | 10.0 | 5.4 | 5.4 | 4.5 | 0.4 | 1.8 | constant | 0.4 | 0.5 | Comp. Ex. |
| 26 | 2.0 | 1530 | 12 | 10.0 | 6.9 | 6.9 | 6.5 | 0.5 | 3.25 | constant | 0.4 | 0.0 | Comp. Ex. |
| 27 | 2.0 | 1530 | 12 | 10.0 | 6.9 | 6.9 | 3.0 | 0.2 | 0.6 | constant | 0.4 | 1.5 | Example |
| 28 | 2.0 | 1530 | 12 | 10.0 | 6.9 | 6.9 | 3.0 | 0.1 | 0.3 | constant | 0.4 | 0.5 | Comp. Ex. |
| 29 | 2.0 | 1515 | 0.6 | 8.0 | 6.9 | 6.9 | 4.0 | 0.4 | 1.6 | constant | 0.4 | 2.0 | Example |
| | | (*4) | | | | | | | | | | | |

In column Ia of Table 1, when Ia changed within the preliminary conduction interval, the average value thereof is set as Ia (*1 of Table 1). Ia (kA) of treatment number 10 increased linearly from 3.0 kA to 5.0 kA (*5 of Table 1). The column “Current Integration Value S of Preliminary Conduction (kA·s)” of Table 1 is the value of the current integration value S in preliminary conduction as prescribed in formula (3) above.

Furthermore, in the column “Ib Waveform” of Table 1, when Ib changed within the main conduction interval, the average value thereof was set as Ib, and the suitable current range was evaluated based on this Ib value (*2 of Table 1). In this column, continuous conduction at a constant current was labelled as “constant.” Ib of treatment number 11 represents an upslope conduction pattern, wherein the current increased linearly such that the current differed by 1.0 kA from the start of main conduction to the end (*7 of Table 1). Since the current Ib linearly increased, the suitable current range of treatment number 11 in Table 1 was the suitable range of the current at the start of main conduction, the current at the end of main conduction, or the average current. Ib of treatment number 12 represents pulsation conduction in which, after continuous conduction at a constant current, the final 0.11 seconds include 0.04 seconds of conduction and 0.015 seconds of conduction idling for two repetitions (*8 of Table 1).

Furthermore, though column “t(b)” of Table 1 includes both conduction and idle time in tb in the case in which conduction and idling are repeated, as in pulsation conduction, the conduction idle time between preliminary conduction and main conduction has been excluded from ta and tb (*3 of Table 1).

In treatment number 13, in the values of ta, after continuous conduction at a constant current, the pulsation method was performed for the final 0.11 seconds (0.04 seconds of conduction and 0.015 seconds of conduction idling were repeated twice (*6 of Table 1)).

Furthermore, in treatment 29 of Table 1, only the sheets of the present invention were non-hot-stamped steel sheets which were alloyed and hot-dip galvanized. The contact resistances thereof were 1 mΩ or less (*4 of Table 1). This is likely because an oxide layer such as ZnO was not present on the surface layer, since hot-stamping was not performed.

The embodiments of the present invention have been described above. However, the embodiments described above are merely examples for carrying out the present invention. Thus, the present invention is not limited to the embodiments described above, and the embodiments described above can be appropriately modified and carried out without deviating from the scope of the gist of the present invention.

### INDUSTRIAL APPLICABILITY

According to the present invention, it is possible to suppress spatter when spot welding steel sheets having a substance having a high electrical resistance on the surface layer thereof, such as hot-stamped steel sheets, thereby ensuring a stable nugget diameter.

### REFERENCE SIGNS LIST

1 spot welding electrode
1a upper electrode
1b lower electrode
2 steel sheet
3 plating layer

1. A method for the production of a resistance spot-welded joint in which two or more steel sheets are superposed, and a superposed portion thereof is pressed and energize by an electrode, wherein
a tip diameter of the electrode, which is the diameter of a circle which is equivalent in area to a region in which a surface region of a tip surface of the electrode having a radius of curvature of 40 mm or more is projected onto a surface perpendicular to a direction of pressure of the electrode, is 8.0 mm or more,
the method comprising:
a preliminary conduction step of applying a current Ia(t) (kA) for a conduction time ta seconds so as to satisfy formulas (1) and (2) below while pressing the electrode with a pressure of 5.5 kN or more, and
a main conduction step of energizing while pressing the electrode with a pressure of 5.0 kN or more after the preliminary conduction step, wherein
current in the preliminary conduction step and the main conduction step is direct current, and
80% or more of the conduction method of each of the conduction time ta seconds and the conduction time of the main conduction step is continuous conduction in which conduction is continuously performed,
Ia(t)≤6.0 (kA) formula (1)
0.5(kA·s)≤∫₀^{ta}Iₐ(t)dt≤2.0(kA·s) formula (2),

2. The method for the production of a resistance spot-welded joint according to claim 1, wherein current is increased in the preliminary conduction step.

3. The method for the production of a resistance spot-welded joint according to claim 1, wherein current is increased in the main conduction step.

4. The method for the production of a resistance spot-welded joint according to claim 1, wherein the preliminary conduction step comprises continuous conduction.

5. The method for the production of a resistance spot-welded joint according to claim 1, wherein the main conduction step comprises continuous conduction.

6. The method for the production of a resistance spot-welded joint according to claim 1, wherein a contact resistance of at least one of the steel sheets is 1 mΩ or more.

7. The method for the production of a resistance spot-welded joint according to claim 1, wherein the tip diameter of the electrode is 8.5 mm or more.
